(19) United States
(12) Patent Application Publication
(10) Pub. No.: US 2003/0229526 A1
(43) Pub. Date: Dec. 11, 2003

(54) Computer-implemented system and method for assessing supply chain solutions

(76) Inventors: Jeffery K. Gallacci, Duvall, WA (US); James H. Herman, Englewood, CO (US); F.A. William Davis III, Lone Tree, CO (US)

Correspondence Address: Kramer Levin Naftalis & Frankel LLP, 919 Third Avenue, New York, NY, 10022, US

(21) Appl. No.: 10/406,828

(22) Filed: Apr. 3, 2003

Related U.S. Application Data
(60) Provisional application No. 60/370,025, filed on Apr. 4, 2002.

(51) Int. Cl. G06F 17/60

(52) U.S. Cl. 705/7

(57) ABSTRACT

A computer-based system and method to enable a component supplier to provide supply chain service solutions that meet the needs and requirements of its customer. The supply chain needs and requirements of the customer and other customer metrics are obtained via responses to information requests having pre-selected response options. Each response to an information request is mapped to a table containing possible supply chain service solutions pre-selected as appropriate for the response. The table also provides a value (to the customer) weight and a risk (to the supplier) weight associated with implementing possible supply chain service solutions. These results are then used to provide the possible supply chain service solutions as well as a graphical assessment of the associated risk versus the value.

### CROSS REFERENCE TO RELATED PROVISIONAL APPLICATION

This application claims the benefit of U.S. Provisional Patent Application No. 60/370,025 filed on Apr. 4, 2002.

### BACKGROUND OF THE INVENTION

The present invention is directed generally to a computer-implemented system and method for assessing supply chain service solutions and, more particularly, to an interactive tool that can be used by a component parts supplier to simultaneously assess the risk to the supplier and value to its customers in proceeding with supply chain service solutions for such customers.

Manufacturers of products, particularly, for example, electronic products such as computers and the like, utilize many component parts during the manufacturing process. Such component parts may be obtained from various sources including a manufacturer of such component parts or a distributor. Distributors purchase or have access to component parts from various parts manufacturers and warehouse such parts directly or indirectly. At any given time, thousands of different parts must be made available to manufacturers, and the distributor must keep up to date with respect to obsolete parts, dropped parts, replacement parts and added parts.

In selecting distributors, customers typically look to more than just price. Distributors may be evaluated on the basis of the total quality of the service that they provide, of which price is merely one aspect. Distributors have developed a number of supply chain service solutions to create value for customers, including programs to help customers track and manage inventory, forecast demand, evaluate and select the most appropriate components, track component obsolescence and improvement, analyze supply chains, and discover alternative components and sources. In addition, distributors can offer customers a variety of custom tailored financing, service, and delivery options. Distributors, where appropriate, may offer larger customers on-site staffing to support the customers' procurement and inventory management processes. Distributors may offer customized packages of multiple components which simplify the customers' warehousing and transportation processes. Distributors may offer customers software to help them manage inventory, or to provide customers with a constant flow of real time data including component availability and lead times, order tracking, customer specific pricing information, reports on the customers' component usage trends, and product alerts. There are many other conventional ways in which a distributor may create value for customers.

Customers vary greatly in their size, purchase volume, demand variance, credit profile, information technology systems, inventory management and procurement methodologies, and priorities. Accordingly, the benefits, costs, and risks associated with providing value added supply chain services vary from customer to customer. For example, while it may be a good idea for a distributor to provide a large customer having complex ordering needs on-site support staff, the associated cost of the service may make it a poor decision to offer to another customer who has simpler ordering needs.

Accordingly, the better able a distributor is in tailoring its services to the specific needs of its customers, the more successful it will be at retaining existing customers and attracting new ones. Distributors who are equipped to make informed decisions on which services to offer to their customers are better able to offer their customers value, while at the same time minimizing costs and exposure to risk.

The present invention provides a new tool for suppliers, particularly of electronic component parts, to provide customers with value added services in the form of tailored supply chain service solutions based on a simultaneous assessment of the value to the customer associated with such solutions and the risk to the distributor in implementing such solutions.

### SUMMARY OF THE INVENTION

Generally speaking, the present invention provides a computer-based system and method that enables a component parts supplier to interact with a customer, obtain customer information and other customer metrics including supply chain needs and requirements, and provide proposed supply chain service solutions to the customer based on the customer information and a simultaneous evaluation of the value to the customer and the risk to the supplier in proceeding with the proposed solutions. The inventive system and method can be used by a salesperson or other representative of the supplier when interacting with the customer.

According to the preferred embodiment of the method of the present invention, information concerning the customer is obtained by presenting information requests having associated pre-defined response options and soliciting selections of the pre-defined response options. The selected pre-defined response options are then associated with supply chain service(s) pre-selected as appropriate for the pre-defined response options. The selected pre-defined response options are further associated with non-qualifying service(s) pre-selected as inappropriate for the pre-defined response options, based on application and/or customer capability and/or cost. Each one of the pre-selected supply chain services has an assigned weighted risk factor and weighted value factor. The weighted risk factor represents the risk to the supplier associated with providing the pre-selected supply chain service; and the weighted value factor represents value to the customer associated with receiving the pre-selected supply chain service. Based on the weighted risk and weighted value factors assigned to each one of the pre-selected supply chain services corresponding to the selected response options, an overall indication of risk to the supplier and an overall indication of value to the customer is calculated. These overall indications of risk and value are then simultaneously correlated, and based on such correlation, appropriate pre-selected supply chain services are presented for possible implementation.

Additionally, the information concerning the customer including the selected pre-defined response options can be displayed for verification prior to associating the selected pre-defined response options with appropriate pre-selected supply chain services. Also, directions for implementing the appropriate pre-selected supply chain services can be generated; and the overall risk and value can be graphically displayed.

The system according to the preferred embodiment of the present invention provides means for effecting the foregoing method steps.

According to additional embodiments, the foregoing method and system of the present invention are implemented in an Internet web browser environment.

Accordingly, it is an object of the present invention to provide a computer-implemented system and method for assessing supply chain service solutions for customers.

Another object of the present invention is to provide a system and method for assessing supply chain solutions which provide an indication of both the value to a customer in implementing proposed supply chain solutions and the relative risk to the supplier in implementing the solutions.

Yet another object of the present invention is to provide a software based tool that can be used by sales representatives of a supplier of component parts in evaluating available value added supply chain services for customers.

Still other objects and advantages of the invention will in part be obvious and will in part be apparent from the specification.

The present invention accordingly comprises the various steps and the relation of one or more of such steps with respect to each of the others, and the system embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1 is a flow chart depicting a process for determining and assessing supply chain solutions according to a preferred embodiment of the present invention;

FIG. 2 is a flow chart depicting a process for creating a supply chain services assessment tool in accordance with a preferred embodiment of the system and method of the present invention;

FIG. 3 depicts a representative computer interface used to input customer information according to a preferred embodiment of the system and method of the present invention;

FIGS. 4-10 depict representative database files associated with information requests presented via the computer interface depicted in FIG. 3 in accordance with a preferred embodiment of the system and method of the present invention;

FIG. 11 depicts a representative report of supply chain service solutions and a risk/value correlation generated in accordance with a preferred embodiment of the system and method of the present invention; and

FIG. 12 is a schematic diagram of a system constructed and arranged in accordance with a preferred embodiment of the present invention.

### DETAILED DESCRIPTION OF THE PREFERRED EMBODIMENTS

As described in detail hereinafter, the present invention is directed to a computer-based system and process which enables a salesperson or other representative of a component supplier to evaluate a customer's needs and requirements, preferably regarding a supply chain of component parts, and to obtain and assess service solutions that address the customer's needs and requirements for proposal to the customer if appropriate based on the risk to the supplier of implementing the solutions in view of the value to the customer. Supply chain service solutions can include various combinations of physical, informational, technical, financial and other services provided by the supplier to the customer that provide value to the customer through increases in efficiencies in various areas of supply chain management and logistics. However, a range of risk exists wherein it is possible that the supplier will not be able to recover the costs associated with providing such service solutions.

Supply chain service solutions also include a range of complexity from simple buffer inventory stocking solutions to complex inventory and staffing solutions on-site at the customer that include integration of several services managing thousands of customer part numbers. The system and method according to the present invention desirably categorize supply chain services into separate classifications including financing, physical value added services, materials management services (simple and complex), and services without parts (e.g., business needs analysis).

The system and method according to the present invention can be implemented using a related combination of automated interfaces and manual processes. It should be appreciated, however, that greater use of automated processing and a wider range of features with multiple executions are also contemplated by the present invention.

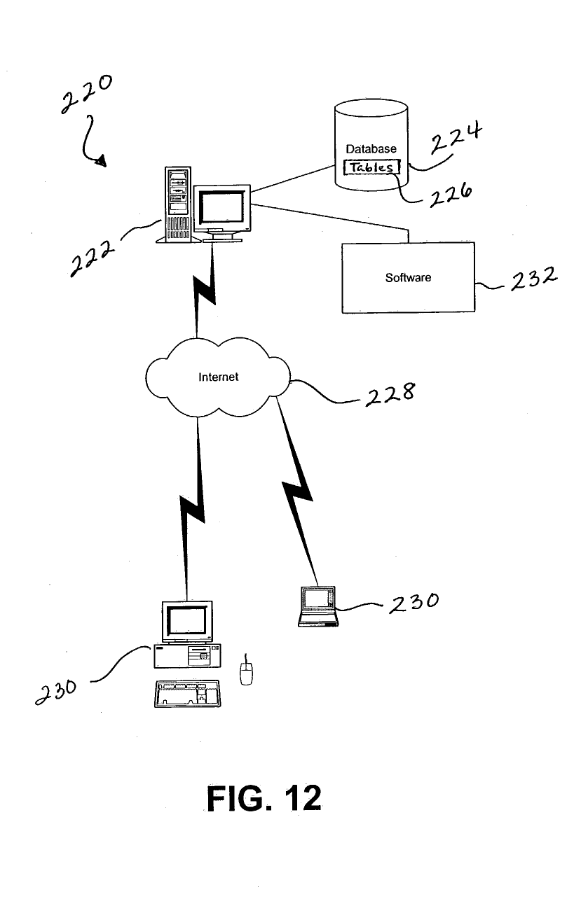

Referring now to the drawings where like reference numerals indicate like elements, FIG. 12 depicts a simplified schematic illustration of a preferred system, shown generally at 220, including the component elements and means necessary to effect and control the various process steps according to the present invention as described hereinafter. Desirably, and where appropriate, system 220 utilizes existing computer capabilities, both hardware and software, and electronic communications links, for example, to receive and process in real time information concerning a customer and to present appropriate proposed supply chain service solutions together with and based on an associated risk versus value assessment as described in greater detail hereinafter.

System 220 preferably includes a computer server 222 having electronic access to a database 224 containing files or tables 226. Server 222 can be electronically coupled to a global computer network 228 such as, for example, the Internet. Server 222 is capable of communication with at least one user interface 230, which can include conventional computer input, output and display devices. User interface 230 is preferably a remote computer interface capable of connection to server 222 via network 228. It should be understood that system 220 may be implemented by other known methods of computer networking and that the use and arrangement of component devices is not restricted to that which is described herein and depicted in the accompanying drawings.

Server 222 preferably operates under control of computer software 232 to carry out the inventive process steps described in greater detail hereinafter. Because the process according to the present invention is desirably effected in real time over the Internet, the system software preferably includes XML, XSL, HTML, VML and JavaScript capability to prepare and present information in an Internet web browser format. More particularly, the system software preferably includes a graphical user interface component—an HTML document which contains a collection of elements that permits a system user to enter data, make selections, and view and print results. This collection of elements can include data stored in XML data islands and JavaScript arrays. Data stored in XML data islands can be used in the various features of the graphical user interface that are populated with data (for example, select options, results, etc.) and, as described in greater detail hereinafter, preferably include a list of customer attributes with supply chain services appropriate for those attributes, and supply chain service solutions based on the attributes. This data can be rendered in HTML using XSL transformations and style sheets. The data stored in JavaScript arrays can be structured to support the complex logic of the risk/value assessments and recommendations to the customer described in greater detail hereinafter. JavaScript functions are preferably created to process user input, allow navigation of the user interface and to manipulate the data. The complex logic of the risk/value analysis as described in greater detail hereinafter can be implemented with JavaScript functions. VML charts are preferably created to represent results graphically, and HTML pages are preferably created to render the results in an Internet web browser.

System software 232 enables the input of customer attributes and specified supply chain needs and requirements in response to a set of information requests and associated pre-defined response options presented by system 220 of the present invention. As described in greater detail hereinafter, database 224 can be used to map the information requests and selected response options to proposed supply chain service solutions and provide associated value (to the customer) factors and risk (to the supplier) factors.

It will be appreciated that the inventive system and method permits the supplier representative to make proposals to the customer concerning supply chain services while advising the customer of the value presented by such proposals. Additionally, the system indicates to the supplier representative the potential risks to the supplier's business associated with the supply chain service proposals.

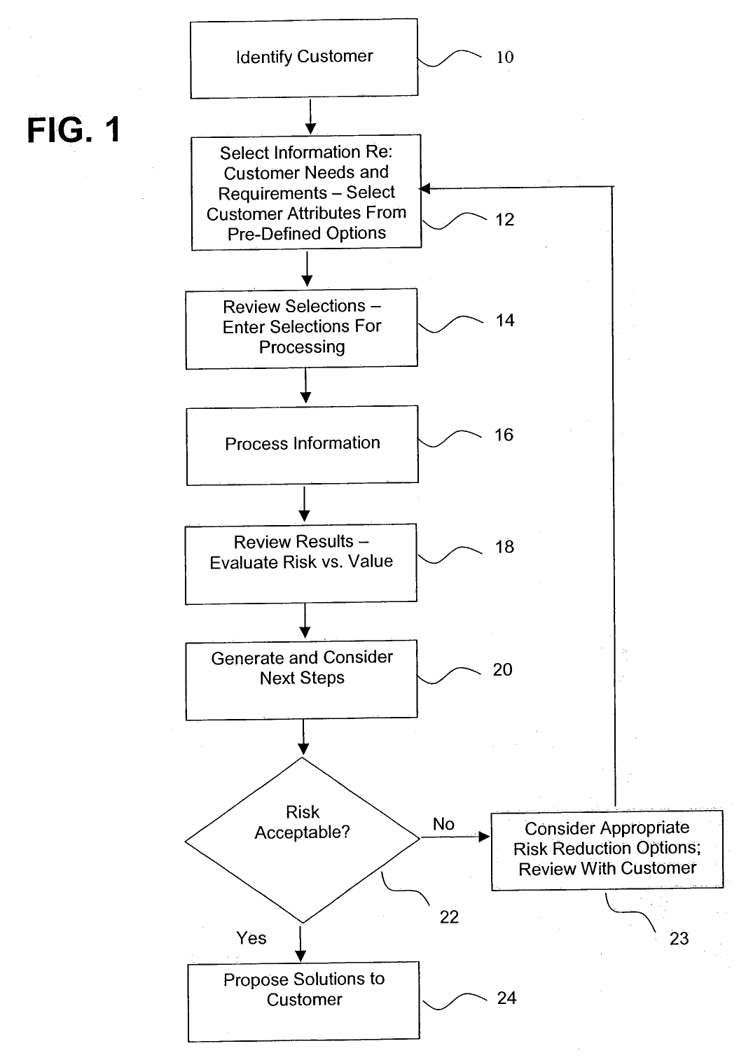

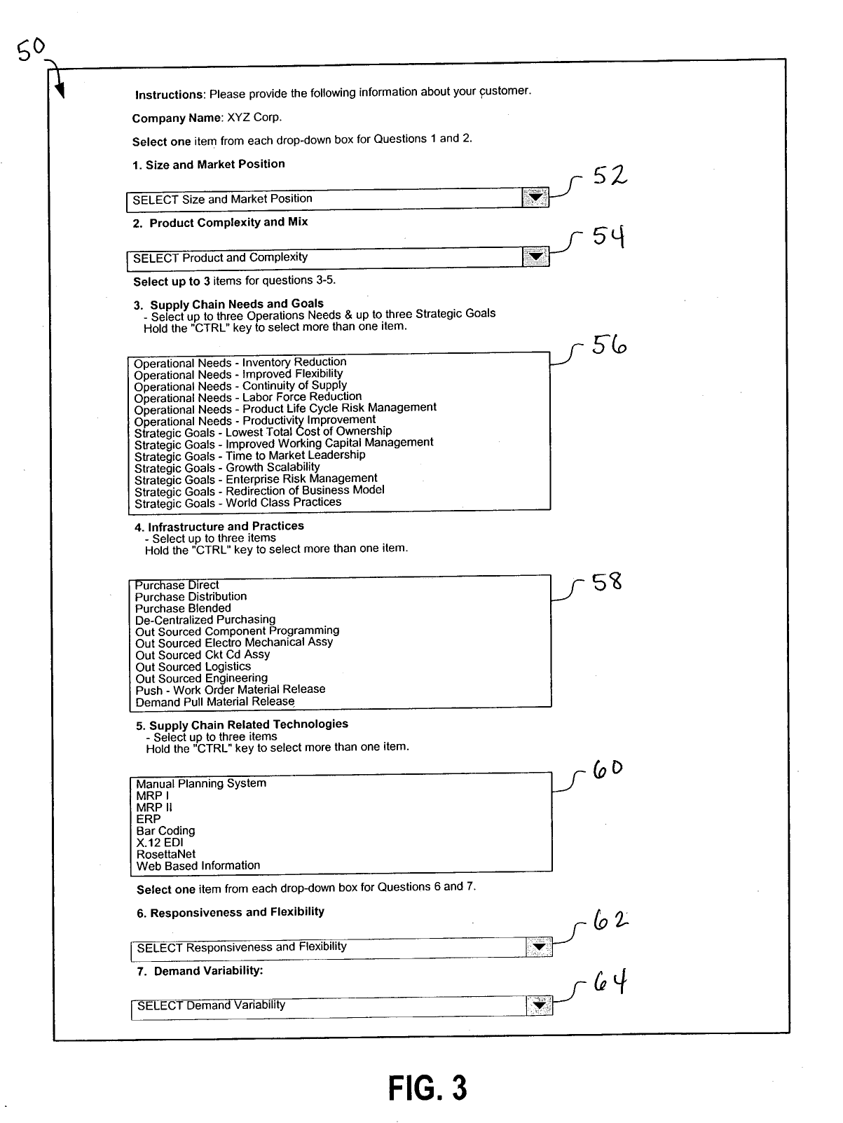

Referring now to FIG. 1, a preferred process according to the present invention is shown whereby a sales or other representative of a component supplier can obtain and use data concerning a customer and its supply chain needs and requirements to obtain a simultaneous assessment of the value to the customer and the risk to the supplier of implementing a proposed supply chain service solution. In a first step 10, the supplier representative inputs data identifying the customer whose supply chain needs and requirements are to be assessed. Information concerning the customer's business, needs and requirements is then solicited (step 12). Preferably, this is accomplished via a user interface screen which is arranged and constructed to capture customer information by text entry and/or through the solicitation of responses to various information requests and associated pre-defined response options concerning customer attributes which can be presented for selection, for example, via drop-down menus (see FIG. 3), as described in greater detail hereinafter.

It should be understood that while the information requests are preferably supplied over a telecommunications medium (e.g., over a global computer network such as the Internet), they can also be supplied, for example, via stand-alone computer software (e.g., contained on media such as a CD-ROM or floppy disk and then stored on a hard disk). The information requests can therefore be accessed on a computer connected to a network which can be the Internet or a local or wide area dedicated or private network or on a stand-alone computer. It should also be appreciated that the process of obtaining customer attributes and other information can occur at an online location such as, for example, the customer's office or the supplier's office.

Entries and responses/selections to the information requests can be displayed desirably in summary form so that, in a step 14 of the process according to the present invention, the entries and responses/selections can be reviewed, verified, and then entered for processing by system 220.

Processing, which occurs at a step 16, involves mapping or otherwise associating the information request response options selected to appropriate supply chain service solutions and the associated value and risk factors as described in greater detail hereinafter.

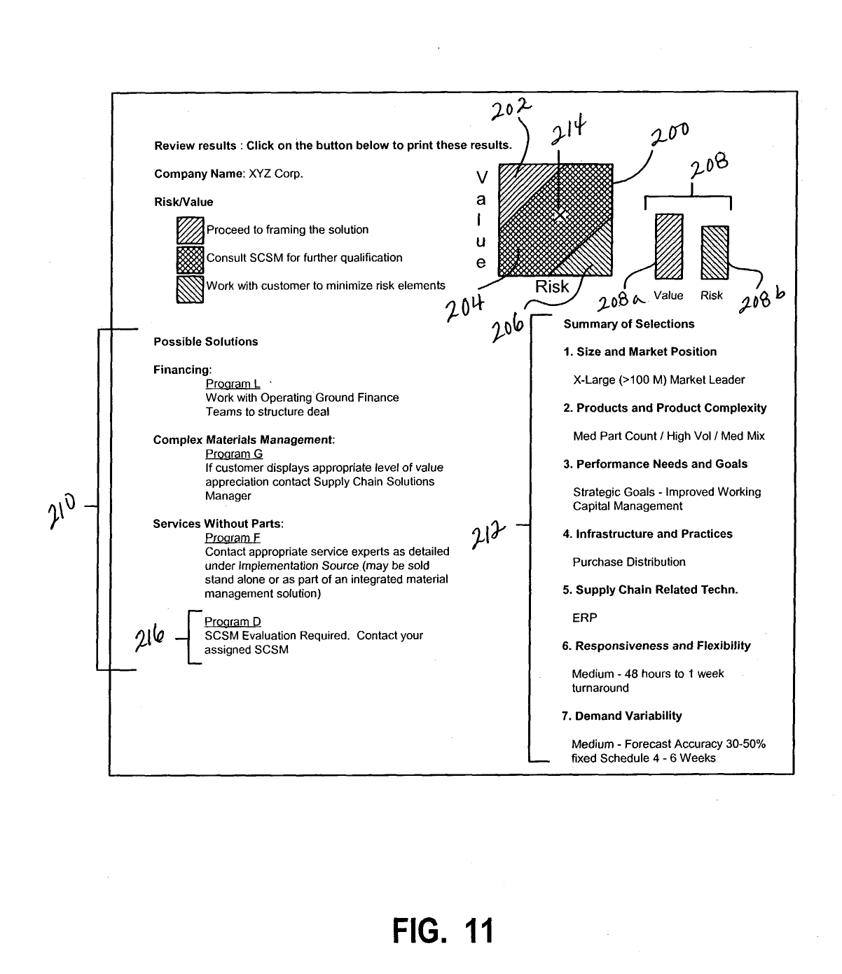

After processing (step 16), results are preferably presented in summary form (summary of selections 212, FIG. 11) for review and evaluation by the supplier representative (step 18). The results include the supply chain service elements of the proposed customer solutions based on the customer attributes (determined in step 16) and an associated risk versus value correlation for use by the supplier representative in evaluating the value to the customer and the risk to the supplier's business regarding the proposed supply chain solutions, as described in greater detail hereinafter.

Thereafter, based on the risk versus value correlation, directional steps for proceeding are provided for consideration by the supplier representative (step 20), and the proposed supply chain service solutions can be presented to the customer (step 24), particularly if the risk level associated with implementing such steps is acceptable to the supplier in view of the value that can be created for the customer (decision 22). In the event the responses/selections to the information requests and other entries produce a risk versus value correlation where the risk to the supplier is unacceptable given the value to the customer (decision 22), alternative risk reduction scenarios can be considered (step 23) and processed based on appropriate new entries and responses/selections to the information requests (i.e., revisiting step 12) to yield a different risk versus value correlation (e.g., certain performance needs and goals may not be selected, and/or additional infrastructure and practices may be added). The appropriate alternative risk reduction scenarios are desirably reviewed with the customer. Supply chain service solutions based on alternative scenarios can be presented to the customer if appropriate (step 24).

The results including the details of any proposed supply chain service solutions can be stored and/or printed for ready reference.

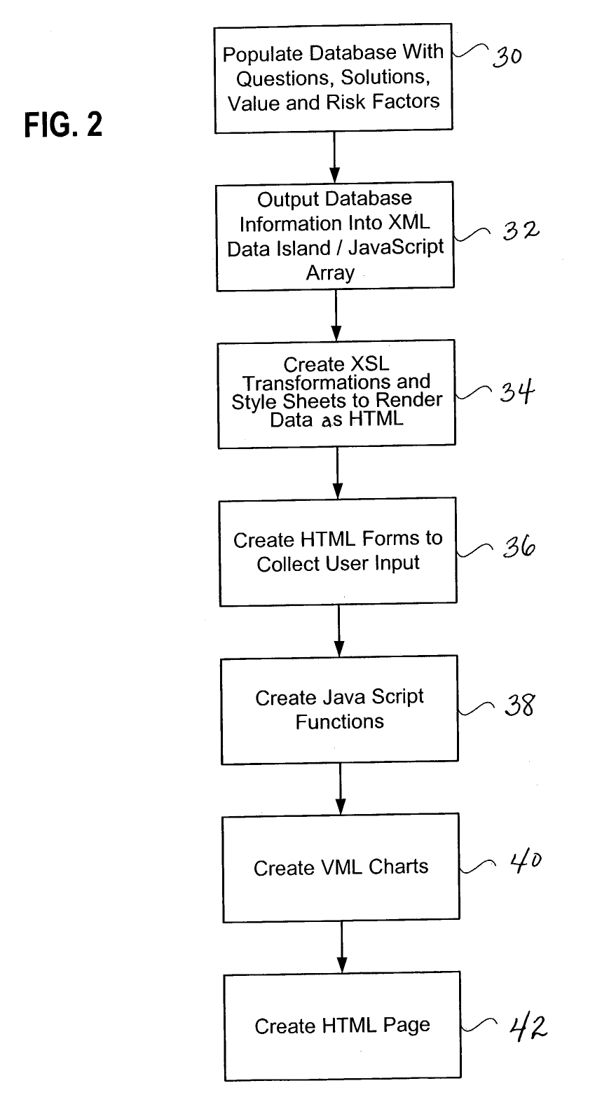

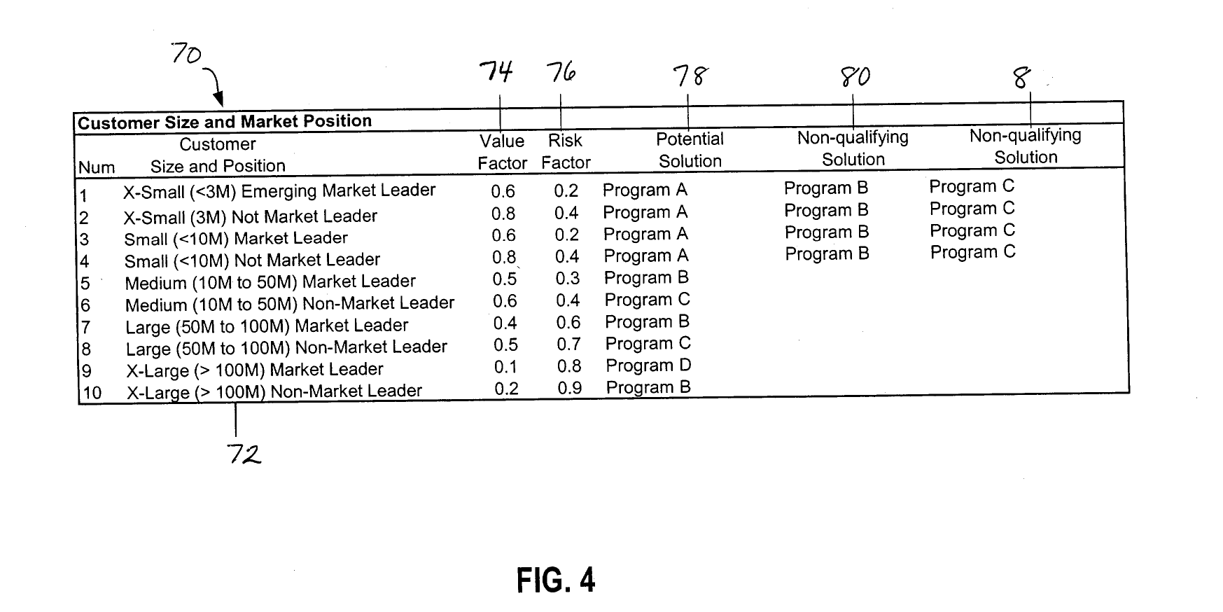

Reference is now made to FIG. 2 of the drawings which depicts a flowchart illustrating the process of creating a supply chain services assessment tool according to a preferred embodiment of the present invention. In a first step 30, database 224 is preferably populated with (i) pre-defined response options concerning customer attributes designed to elicit customer information that can facilitate the formulation of associated supply chain service solution proposals for such customer (FIG. 3), (ii) supply chain service solutions associated with such options and customer responses thereto (Programs A-T in the representative database tables depicted in FIGS. 4-10, representing various combinations of physical, informational, technical, financial and other services provided by the supplier to the customer), (iii) value factors associated with such options and customer responses thereto representative of the value to the customer in implementing supply chain service solutions (FIGS. 4-10) and (iv) risk factors associated with such options and customer responses thereto identifying risk to the supplier in implementing such solutions (FIGS. 4-10).

The potential supply chain service solutions (Programs A-T) desirably represent customized and tested solutions that can be implemented to satisfy customer supply chain needs and requirements. The solutions are preferably tailored to the risk and value factors which are associated with each of the information requests (FIG. 3) and possible responses thereto.

Possible solutions can include tools for reviewing customer material processes and objectives and best-in-class benchmarking to improve internal processes; planning systems that utilize a customer's forecasts to automate and drive the fulfillment process by comparing customer demand to the supplier's inventory levels and automating and integrating supplier and customer systems to ensure inventory pipeline vitality; tools that provide immediate access to supply chain information to identify and take immediate action if problems arise; tools that provide access to customer-specific research and ordering information; and providing analysis and other value added supply chain services that optimize and streamline supply chain management.

The risk and value factors can be based primarily on the quantitative and qualitative experience of the supplier in providing supply chain solutions for its customers. That is, a risk factor (preferably, a weighted numeric value) is assigned to each supply chain service based on the supplier's quantitative and qualitative historical relative risk experience regarding the service compared to other services offered by the supplier (e.g., credit and payment history, number of standard versus non-standard component parts sold); and a value factor (preferably, a weighted numeric value) is assigned to each supply chain service based on the supplier's quantitative and qualitative historical relative value experience regarding the service compared to other services offered by the supplier (e.g., activity-based costing analysis). Weighted value factors can be decimals between 0.1 and 0.9 with higher value supply chain services relative to other services given a higher weight and lower value supply chain services given a lower weight to produce a greater responsiveness when computing a weighted mean value. Weighted risk factors can be decimals between 0.1 and 0.9 with higher risk supply chain services relative to other services given a higher weight and lower risk supply chain services given a lower weight to produce a greater responsiveness when calculating a weighted mean risk. By weighing value and risk factors as decimals between 0.1 and 0.9, a weighted mean greater than 0 and less than 1 can be obtained, producing a fixed scale result.

The correlation of risk and value in accordance with the system and method according to a preferred embodiment of the present invention (which correlation is preferably effected simultaneously) depends on the nature of the predefined information requests and the customer's responsive selections. For example, referring to FIG. 3, for the information request relating to the size and market position of the customer, numerous factors go into assessing the risk and value factors. For value, the supplier is more likely to offer value to extra small customers that are not market leaders because such customers are traditionally less sophisticated on supply chain management issues and are less likely to have infrastructure in place to efficiently handle supply chain solutions and management. In such cases, the supplier, already having sophistication and infrastructure in this area, will likely provide a high level of value. For extra large customers, the supplier is likely to provide less value since such customers can be expected to have a high level of sophistication in procurement matters and well developed supply chain infrastructure.

Similarly, risk to the supplier can be based on the size of the customer. For example, small customers are more likely to pose less of a risk to the supplier because of their reliance on the supplier's sophistication and infrastructure; empirically, small customers tend to be more loyal to suppliers. On the other hand, large customers tend to diversify, outsource or otherwise change their supply chain solutions and relationships thereby increasing the risk to the supplier that may have invested in infrastructure to support the customers.

Referring again to FIG. 2, after database 224 is populated (step 30), database information is preferably output into an XML data island and JavaScript array (step 32). Data in the XML data island preferably include the pre-defined customer attributes with supply chain services appropriate for such attributes, non-qualifying services that are not appropriate for such attributes because of application and/or customer capability and/or cost, and supply chain service solutions based on combinations of such attributes. Data in the JavaScript array preferably support the risk and value factors, possible supply chain services and directional steps for proceeding with proposed supply chain service solutions.

In a step 34, XSL transformations and style sheets are preferably created to render the data from database 224 as HTML pages. In a step 36, HTML forms are preferably created to collect user input. Thereafter, in a step 38, JavaScript functions are preferably created to process user input, navigate the user interface (FIG. 3) and allow manipulation of the data, including to implement the complex logic of the simultaneous risk/value assessment. In a step 40, VML charts are preferably created to represent results (e.g., risk/value results) graphically. In a step 42, an HTML page is preferably created to render results (e.g., risk/value results) in a web browser.

Reference is now made to FIG. 3 which shows an example user interface, generally indicated at 50, used to present information requests and capture responses thereto in accordance with the system and method of the present invention. Desirably, information requests can elicit response through various pre-defined response options available for selection from, for example, a window, drop-down menu or the like.

A request for information concerning a customer, for example, can be directed to the size and market position of the customer and can be presented for selection via a drop-down menu 52. As shown in database table 70 of FIG. 4, response options 72 for a request regarding customer size can range, for example, between an extra small customer as an emerging market leader to an extra large customer as a non-market leader. Additionally, as shown in FIG. 4, each selectable response option 72 is preferably mapped in database table 70 to a weighted value factor 74, a weighted risk factor 76, a potential solution 78, and any non-qualifying solutions 80. These factors can be utilized in determining supply chain solutions that balance value to the customer against risk to the supplier. The value factors, risk factors, potential solutions and non-qualifying solutions presented are preferably based on the experience of the supplier.

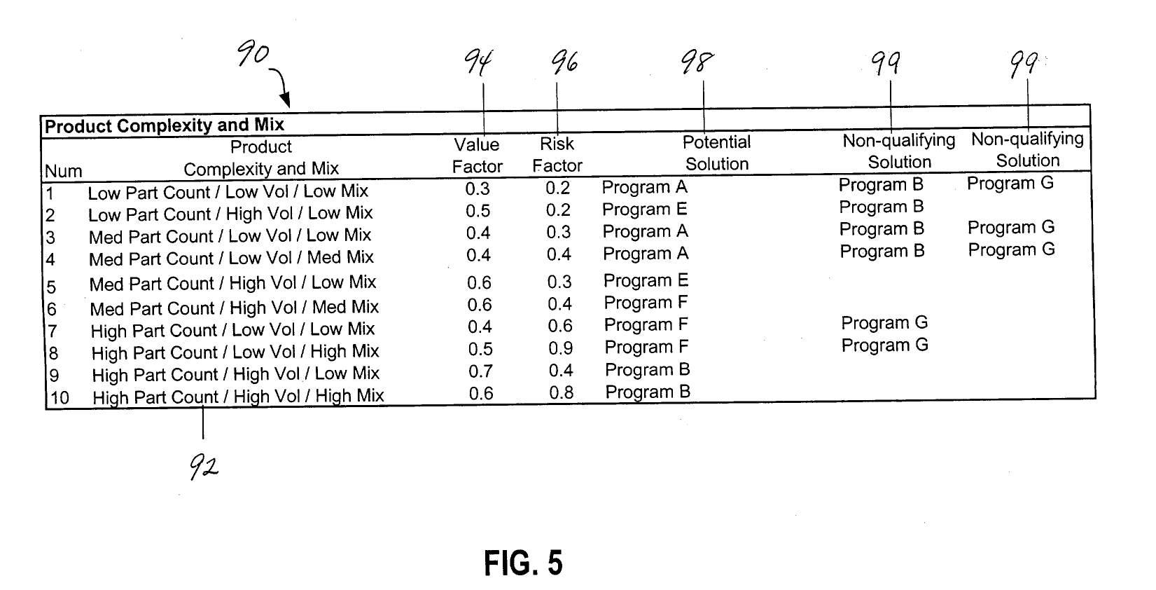

Referring again to FIG. 3, in addition to the size and market position of a customer, information request response options concerning customer product complexity and mix can be presented using a drop-down menu 54, for example. Referring to database table 90 in FIG. 5, selectable response options indicated at 92 can be provided ranging, for example, from a low part count/low volume/low mix selection to a high part count/high volume/high mix selection. Each selected response option preferably is mapped to or associated with a weighted value factor 94, a weighted risk factor 96, a potential solution 98, and any non-qualifying solutions 99.

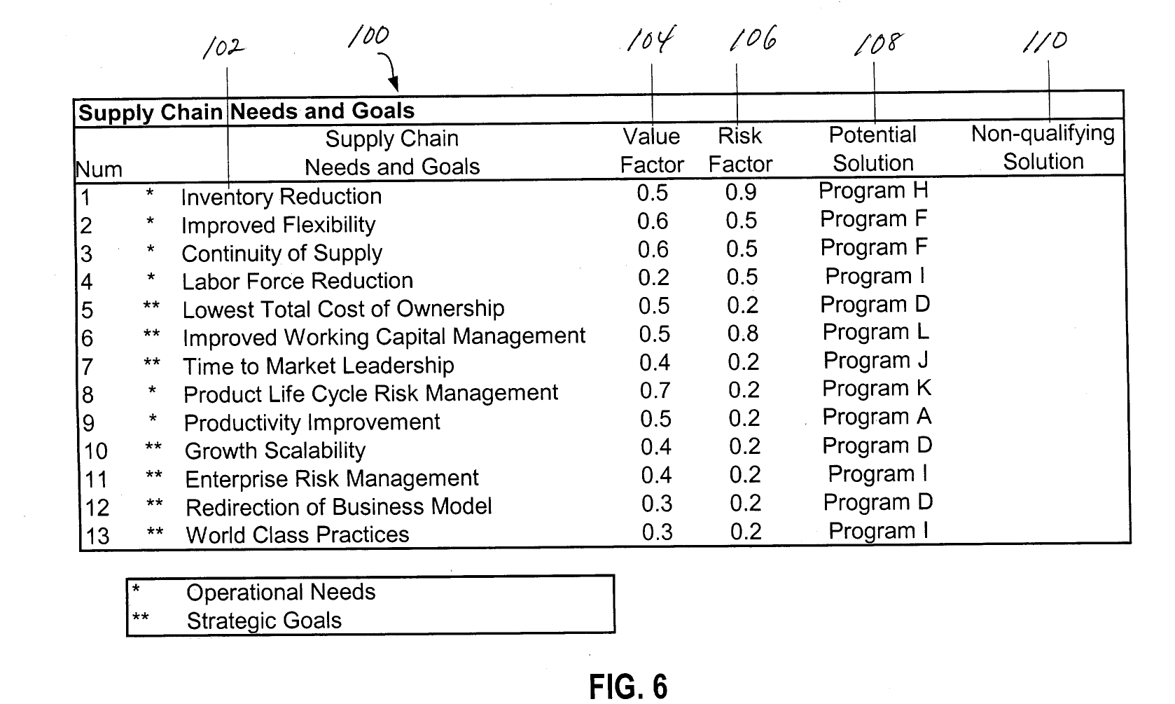

Referring back to FIG. 3, an information request to identify supply chain needs and goals and associated response options, i.e., one or more (e.g., three) operational needs and one or more (e.g., three) strategic goals identified as such, can be presented via a window 56, for example. While in the example depicted in FIG. 3, six operational needs (i.e., inventory reduction, improved flexibility, continuity of supply, labor force reduction, product life cycle risk management, and productivity improvement) and seven strategic goals (i.e., lowest total cost of ownership, improved working capital management, time to market leadership, growth scalability, enterprise risk management, redirection of business model, and world class practices) are presented for selection, it should be understood that any suitable number of needs and goals can be presented. As depicted in database table 100 of FIG. 6, each operational need and each strategic goal 102 is preferably mapped to or associated with a weighted value factor 104, a weighted risk factor 106, a potential solution 108, and any non-qualifying solutions 110.

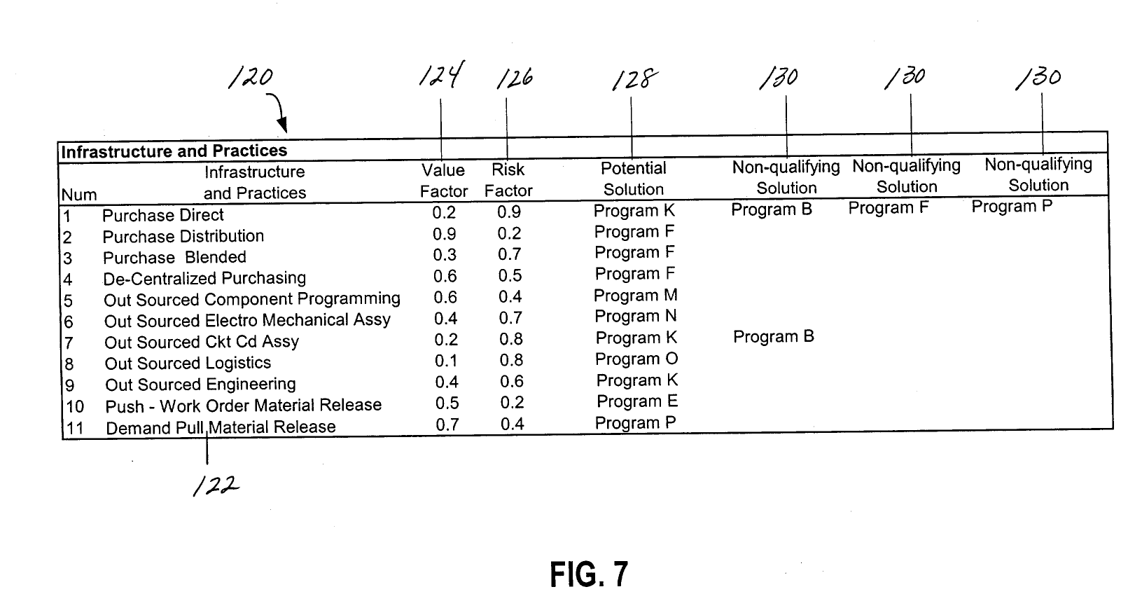

Referring back to FIG. 3, an information request and associated response options relating to the infrastructure and practices of the customer can be presented for selection via a window 58, for example. While in the example depicted in FIG. 3, eleven items (i.e., purchase direct, purchase distribution, purchase blended, decentralized purchasing, outsourced component programming, outsourced electromechanical assembly, outsourced circuit card assembly, outsourced logistics, outsourced engineering, push-work order material release and demand pull material release are presented for selection and the user is asked to select up to three items, it should be understood that any suitable number of items can be presented and requested to be selected. As depicted in database table 120 of FIG. 7, each of the items 122 are preferably mapped to or associated with a weighted value factor 124, a weighted risk factor 126, a potential solution 128, and any non-qualifying solutions 130.

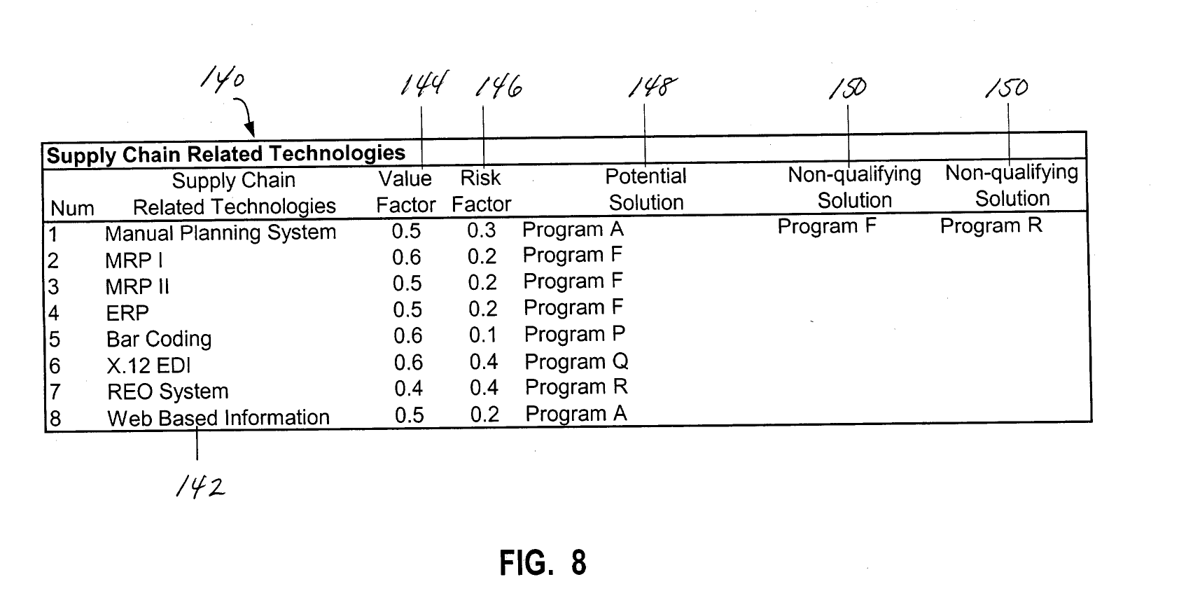

Referring again to FIG. 3, an information request relating to the customer's supply chain related technologies and associated response options can be presented for selection via a window 60, for example. While in the example depicted in FIG. 3 eight proposed supply chain related technologies (ranging from a manual planning system, manufacturing resource planning systems, and enterprise resource planning systems to web-based information systems) are presented for selection, and the user is asked to select up to three technologies, it should be appreciated that any suitable number of technologies can be presented and requested to be selected. As shown in database table 140 of FIG. 8, each of the technologies presented for selection 142 is preferably mapped to or associated with a weighted value factor 144, a weighted risk factor 146, a potential solution 148, and any non-qualifying solutions 150.

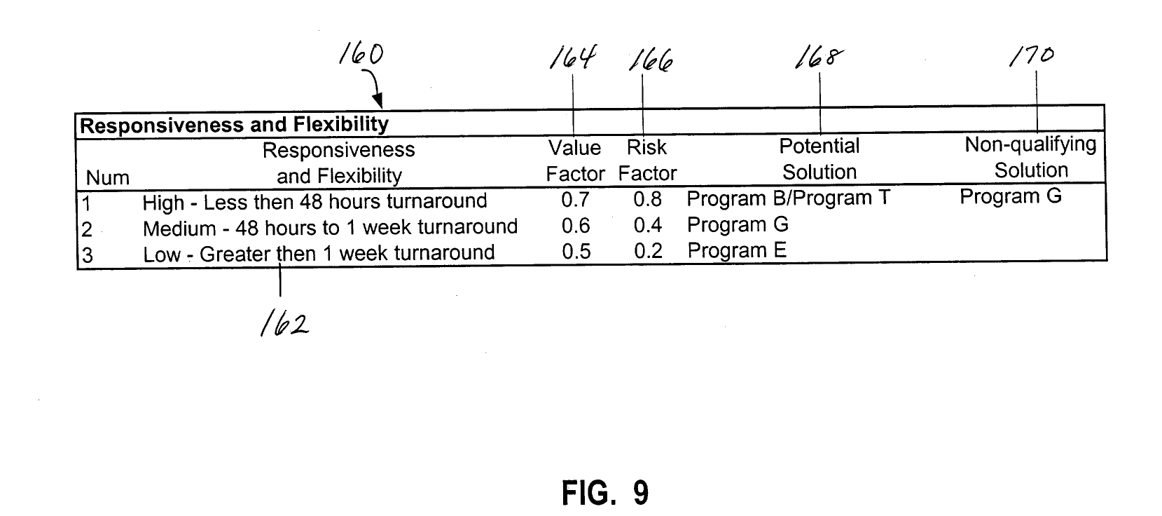

Referring back to FIG. 3, an information request and associated response options concerning the responsiveness and flexibility (either actual or desired) of the customer can be presented for selection via a drop-down menu 62, for example. While in the example depicted in FIG. 3 three response options are presented for selection (see FIG. 9, database table 160), and the user is asked to select one, it should be appreciated that any suitable number of options can be presented and requested to be selected. As shown in database table 160 of FIG. 9, response options 162 presented for selection can include, for example, (1) a high flexibility with a less than 48 hour turn around, (2) a medium flexibility with a 48 hour to one week turnaround and (3) a low flexibility with a greater than one week turnaround. Each response option 162 is preferably mapped to or associated with a weighted value factor 164, a weighted risk factor 166, a potential solution 168 and any non-qualifying solutions 170.

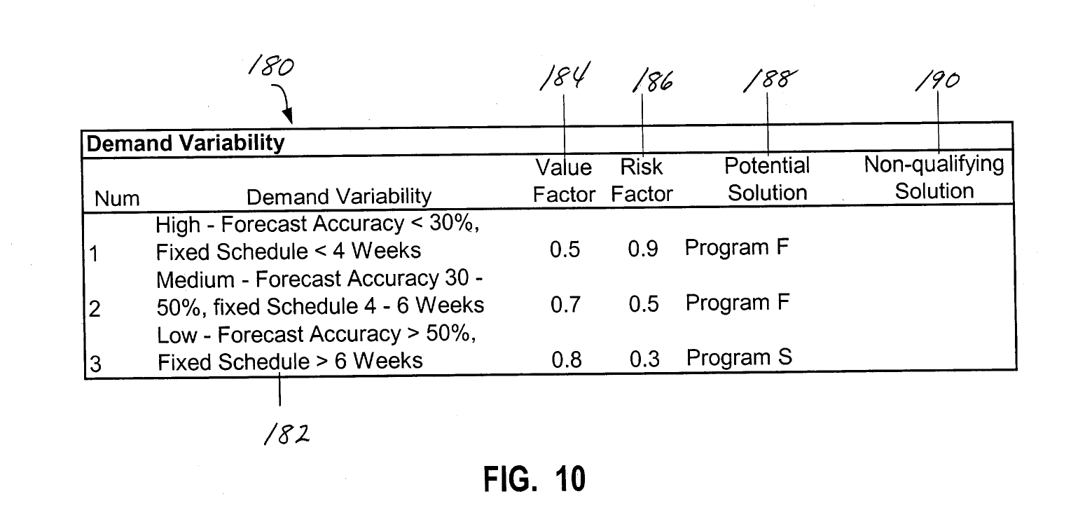

Referring again to FIG. 3, an information request and associated response options concerning demand variability can be presented for selection via a drop-down menu 64, for example. While in the example depicted in FIG. 3 three response options are presented for selection (see FIG. 10, database table 180), and the user is asked to select one, it should be appreciated that any suitable number of options can be presented and requested to be selected. As shown in database table 180 of FIG. 10, response options 182 presented for selection can include, for example, (1) a high demand variability—forecast accuracy of less than 30% with a fixed schedule less than four weeks, (2) a medium demand variability—forecast accuracy of 30-50% with a fixed schedule of from four to six weeks and (3) a low demand variability—forecast accuracy of greater than 50% with a fixed schedule greater than six weeks. Each response option 182 is preferably mapped to or associated with a weighted value factor 184, a weighted risk factor 186, a potential solution 188, and any non-qualifying solutions 190.

After completing responses to the information requests (FIG. 3) via interface 50, the information provided can be processed. This involves associating the selected response options to the appropriate service solutions (and any non-qualifying solutions) and the weighted value and weighted risk factors. Preferably, all weighted value factors for selections made and qualifying services (e.g., from the XML data islands and JavaScript arrays) are computed to arrive at the sum of selections in the array and the sum divided by the total number of selections in the array to yield a weighted mean value factor; likewise, the weighted risk factors for selections made and qualifying services (e.g., from the XML data islands and JavaScript arrays) are preferably computed to arrive at the sum of selections in the array and the sum divided by the total number of selections in the array to yield a weighted mean risk factor. The results can then be used to create a simultaneous graphical representation of risk versus value (FIG. 11).

Reference is now made to FIG. 11 which depicts a representative example of a results display page which can be generated after completion and processing of the responses to the information requests (FIG. 3) as described. Desirably, the results page includes a two-dimensional graph 200 (i.e., having x and y axes) showing risk versus value and defining shaded areas 202, 204 and 206 as described below. Alternatively or additionally, a bar graph 208 including a value bar 208a and a risk bar 208b can be presented. It should be understood that the foregoing can involve defining the risk and value factors in a VML program and displaying simultaneously as a section of an HTML page.

Shaded region 202 of graph 200 represents high value and low risk scores. As indicated in the “Risk/Value” legend or key appearing to the left of graph 200 in FIG. 11, for such a combination of scores, the supplier representative is preferably advised to proceed with framing supply chain service solutions for the customer, which can include articulating and reaching agreement with the customer on such solutions.

Shaded region 204 of graph 200 represents low value and low risk scores, moderate value and risk scores, or high value and high risk scores. For such combinations of scores, the supplier representative is preferably advised to consult with a supply chain solutions representative (“SCSM”) (or other supply chain specialist defined by the supplier), for further guidance and qualification before initiating supply chain service solutions for the customer.

Shaded region 206 of graph 200 represents low value and high risk scores. For such a combination of scores, the supplier representative is preferably advised to work with the customer to minimize risk factors before proceeding with establishing supply chain service solutions.

In the example depicted in FIG. 11, the value 208a, which is shown as being moderately greater than the risk 208b, is that presented by the possible supply chain service solutions 210 depicted (e.g., as a section of an HTML page). A summary of selections entered via interface 50 (FIG. 3) is desirably provided for ready reference at 212 (e.g., as a section of an HTML page).

A point 214 on graph 200 represents the risk and value scores associated with service solutions for the customer under consideration and indicates the course of action that is recommended. In the example depicted in FIG. 11, point 214 is located in the central region of graph 200, indicating moderate risk and value scores and that the supplier representative is advised to consult a SCSM for further guidance and qualification before initiating supply chain service solutions for the customer.

Given the location of point 214 on graph 200 in the example depicted in FIG. 11, a set of four different possible supply chain service solutions 210 are indicated—one relating to financing, one relating to complex materials management and two others relating to services without parts. Each potential solution is listed preferably along with a link to more information about the solution and instructions for proceeding with implementation of the solution. For example, solution 216, states that a SCSM evaluation is required before solution “Program D” can be implemented.

In accordance with the present invention, a computer-based tool for assessing supply chain service solutions is provided which allows a supplier representative to interact with the customer, obtain customer information in the form of responses to pre-selected information request options and to provide proposed supply chain service solutions to the customer based on the customer information and responses and a simultaneous evaluation of the value to the customer and the risk to the supplier in proceeding with the proposed solutions.

It will thus be seen that the objects set forth above, among those made apparent from the preceding description, are efficiently attained and, since certain changes can be made in carrying out the above method and in the constructions set forth for the system without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A computerized method for assessing supply chain services for presentation by a supplier of products to a customer of said products, the method comprising the steps of obtaining information concerning said customer, including by presenting information requests having associated pre-defined response options and obtaining selections of said pre-defined response options, associating said selected predefined response options with supply chain services pre-selected as appropriate for said pre-defined response options, each one of said pre-selected supply chain services having a risk factor and a value factor assigned thereto, said risk factor being representative of risk to said supplier associated with providing said pre-selected supply chain service, and said value factor being representative of value to said customer associated with receiving said pre-selected supply chain service, based on said risk and value factors assigned to each one of said pre-selected supply chain services corresponding to said selected response options, calculating an overall indication of risk to said supplier associated with providing said pre-selected supply chain services and an overall indication of value to said customer associated with receiving said pre-selected supply chain services, correlating said overall indications of risk and value, and based on said correlation of overall risk and value, presenting appropriate ones of said pre-selected supply chain services for possible implementation.

2. The method according to claim 1, further comprising the step of associating said selected pre-defined options with non-qualifying services pre-selected as inappropriate for said pre-defined response options.

3. The method according to claim 1, further comprising the step of displaying said information concerning said customer, including said selected predefined response options, for verification by at least one of said supplier and customer prior to said step of associating said selected pre-defined response options with said appropriate pre-selected supply chain services.

4. The method according to claim 1, further comprising the step of providing directions for implementing said appropriate ones of said pie-selected supply chain services.

5. The method according to claim 1, further comprising the step of graphically displaying said correlation of overall risk and value.

6. The method according to claim 5, wherein said correlation of overall risk and value is represented as a point on a two-dimensional graph defined by x and y axes, said graph including a plurality of pre-defined regions, each of said regions being associated with a different pre-selected recommended course of action for said supplier regarding said customer, the location of said point on said graph with respect to said pre-defined regions indicating an appropriate one of said recommended courses of action.

7. The method according to claim 6, wherein said graph includes a first pre-defined region representing high overall value and low overall risk.

8. The method according to claim 7, wherein said pre-selected recommended course of action associated with said first pre-defined region is to proceed with framing said supply chain services for said customer.

9. The method according to claim 6, wherein said graph includes a second pre-defined region representing at least one combination of high overall value and high overall risk, moderate overall value and moderate risk, and low overall value and low overall risk.

10. The method according to claim 9, wherein said pre-selected recommended course of action associated with said second pre-defined region is to consult a supply chain solutions representative of said supplier for further guidance regarding said supply chain services for said customer.

11. The method according to claim 6, wherein said graph includes a third pre-defined region representing low overall value and high overall risk.

12. The method according to claim 11, wherein said pre-selected recommended course of action associated with said third pre-defined region is for said supplier to work with said customer to minimize the costs associated with providing said pre-selected supply chain services before proceeding with said supply chain services for said customer.

13. The method according to claim 5, wherein said correlation of overall risk and value is represented as a bar graph including a first bar representing said overall risk and a second bar representing said overall value.

14. The method according to claim 1, wherein said information requests and said pre-defined response options are provided over a global computer network.

15. The method according to claim 14, wherein said global computer network is the Internet.

16. The method according to claim 1, wherein said pre-selected supply chain services include at least one of physical, informational, technical, and financial services provided by said supplier designed to confer value to said customer through increases in efficiencies in supply chain management and logistics.

17. The method according to claim 1, wherein said appropriate ones of said pre-selected supply chain services presented for possible implementation include those for which said supplier can recover the costs associated with providing said pre-selected supply chain services.

18. The method according to claim 1, wherein said risk factor is based on said supplier's historical risk experience regarding said associated pre-selected supply chain service relative to other supply chain services offered by said supplier.

19. The method according to claim 1, wherein said value factor is based on said supplier's historical customer value experience regarding said associated pre-selected supply chain service relative to other supply chain services offered by said supplier.

20. The method according to claim 1, wherein said risk and value factors are numeric values.

21. The method according to claim 20, wherein said step of calculating an overall indication of risk to said supplier associated with providing said pre-selected supply chain services includes computing the sum of said risk factors assigned to each one of said pre-selected supply chain services corresponding to said selected pre-defined response options to yield a risk factor sum and dividing said risk factor sum by the total number of said selected pre-defined response options.

22. The method according to claim 20, wherein said step of calculating an overall indication of value to said customer associated with receiving said pre-selected supply chain services includes computing the sum of said value factors assigned to each one of said pre-selected supply chain services corresponding to said selected pre-defined response options to yield a value factor sum and dividing said value factor sum by the total number of said selected pre-defined response options.

23. The method according to claim 1, wherein said information requests concern at least one of the identity of said customer, the size of said customer, said customer's market position, said customer's product complexity and mix, said customer's supply chain needs and requirements, said customer's infrastructure and practices, the supply chain related technologies employed by said customer, said customer's responsiveness and flexibility, and demand variability associated with said customer.

24. A system for assessing supply chain services for presentation by a supplier of products to a customer of said products, the system comprising information storage means for maintaining data representing information requests having associated pre-defined response options, supply chain services pre-selected as appropriate for said pre-defined response options, risk factors representative of risk to said supplier associated with providing said pre-selected supply chain services, and value factors representative of value to said customer associated with receiving said pre-Selected supply chain services, means for presenting said information requests and said associated pre-defined response options, input means for obtaining information concerning said customer including for selecting said pre-defined response options, means for assigning appropriate ones of said risk factors and said value factors to each one of said pre-selected supply chain services, means for associating selected ones of said pre-defined response options with said pre-selected supply chain services, means for calculating an overall indication of risk to said supplier associated with providing said pre-selected supply chain services and an overall indication of value to said customer associated with receiving said pre-selected supply chain services based on said risk and value factors assigned to each one of said pre-selected supply chain services, means for correlating said overall indications of risk and value, and means for presenting appropriate ones of said supply chain services for possible implementation based on said correlation of overall risk and value.

25. The system according to claim 24, wherein said data storage means further includes data representing non-qualifying services pre-selected as inappropriate for said pre-defined response options.

26. The system according to claim 24, wherein said information requests concern at least one of the identity of said customer, the size of said customer, said customer's market position, said customer's product complexity and mix, said customer's supply chain needs and requirements, said customer's infrastructure and practices, the supply chain related technologies employed by said customer, said customer's responsiveness and flexibility, and demand variability associated with said customer.

27. The system according to claim 24, wherein said information requests and said pre-defined response options are provided over a global computer network.

28. The system according to claim 27, wherein said global computer network is the Internet.

29. The system according to claim 24, wherein said pre-selected supply chain services include at least one of physical, informational, technical, and financial services provided by said supplier designed to confer value to said customer through increases in efficiencies in supply chain management and logistics.

30. The system according to claim 24, wherein said appropriate ones of said pre-selected supply chain services presented for possible implementation include those for which said supplier can recover the costs associated with providing said pre-selected supply chain services.

31. The system according to claim 24, wherein said risk factors are based on said supplier's historical risk experience regarding said associated pre-selected supply chain service relative to other supply chain services offered by said supplier.

32. The system according to claim 24, wherein said value factors are based on said supplier's historical customer value experience regarding said associated pre-selected supply chain service relative to other supply chain services offered by said supplier.

33. The system according to claim 24, wherein said data are stored in at least one of an XML data island and JavaScript array.

34. The system according to claim 24, wherein said means for presenting said information requests and said associated pre-defined response options and said input means include at least one software program having a graphical user interface component.

35. The system according to claim 34, wherein said graphical user interface component is an HTML document.

36. The system according to claim 35, wherein said HTML document includes said data, said data being received from at least one of an XML data island and JavaScript array.

37. The system according to claim 36, wherein said data are rendered in HTML via XSL transformations and style sheets.

38. The system according to claim 24, further comprising means for displaying said information concerning said customer, including said selected predefined response options, for verification by at least one of said supplier and customer prior to associating said selected pre-defined response options with said appropriate pre-selected supply chain services.

39. The system according to claim 38, wherein said display means includes an HTML document including said data, said data being received from at least one of an XML data island and JavaScript array.

40. The system according to claim 39, wherein said data are rendered in HTML via XSL transformations and style sheets.

41. The system according to claim 24, wherein said means for associating selected ones of said pre-defined response options with said pre-selected supply chain solutions includes at least one JavaScript software program adapted to access at least one of an XML data island and JavaScript array including said data.

42. The system according to claim 24, wherein said risk and value factors are numeric values.

43. The system according to claim 42, wherein said means for calculating an overall indication of risk to said supplier associated with providing said pre-selected supply chain services includes means for computing the sum of said risk factors assigned to each one of said pre-selected supply chain services corresponding to said selected pre-defined response options to yield a risk factor sum and dividing said risk factor sum by the total number of said selected pre-defined response options.

44. The system according to claim 42, wherein said means for calculating an overall indication of value to said customer associated with receiving said pre-selected supply chain services includes means for computing the sum of said value factors assigned to each one of said pre-selected supply chain services corresponding to said selected pre-defined response options to yield a value factor sum and dividing said value factor sum by the total number of said selected pre-defined response options.

45. The system according to claim 24, wherein said means for correlating said overall indications of risk and value includes means for graphically displaying said overall indications of risk and value.

46. The system according to claim 45, wherein said means for graphically displaying said overall indications of risk and value includes at least one VML chart.

47. The system according to claim 45, wherein said means for graphically displaying said overall indications of risk and value includes means for representing said overall indications of risk and value as a point on a two-dimensional graph defined by x and y axes, said graph including a plurality of pre-defined regions, each of said regions being associated with a different pre-selected recommended course of action for said supplier regarding said customer, the location of said point on said graph with respect to said pre-defined regions indicating an appropriate one of said recommended courses of action.

48. The system according to claim 47, wherein said graph includes a first pre-defined region representing high overall value and low overall risk.

49. The system according to claim 48, wherein said pre-selected recommended course of action associated with said first pre-defined region is to proceed with framing said supply chain services for said customer.

50. The system according to claim 47, wherein said graph includes a second pre-defined region representing at least one combination of high overall value and high overall risk, moderate overall value and moderate risk, and low overall value and low overall risk.

51. The system according to claim 50, wherein said pre-selected recommended course of action associated with said second pre-defined region is to consult a supply chain solutions representative of said supplier for further guidance regarding said supply chain services for said customer.

52. The system according to claim 47, wherein said graph includes a third pre-defined region representing low overall value and high overall risk.

53. The system according to claim 52, wherein said pre-selected recommended course of action associated with said third pre-defined region is for said supplier to work with said customer to minimize the costs associated with providing said pre-selected supply chain services before proceeding with said supply chain services for said customer.

54. The system according to claim 45, wherein said means for graphically displaying said overall indications of risk and value includes means for representing said overall indications of risk and value as a bar graph including a first bar representing said overall risk and a second bar representing said overall value.

55. The system according to claim 24, wherein said means for presenting appropriate ones of said supply chain services for possible implementation includes means for displaying said supply chain services within a portion of an HTML document.

56. The system according to claim 24, further comprising means for presenting directions for implementing said appropriate ones of said pre-selected supply chain services.

57. The system according to claim 56, wherein said means for presenting directions includes means for displaying said directions within a portion of an HTML document.

58. A method for providing an Internet-based tool for assessing supply chain services offered by a supplier of products to a customer of products, the method comprising the steps of populating a database with data representing information requests, pre-defined response options to said information requests, supply chain services pre-selected as appropriate for said pre-defined response options, risk factors representative of risk to said supplier associated with providing said pre-selected supply chain services, and value factors representative of value to said customer associated with receiving said pre-selected supply chain services, outputting said data into at least one of an XML data island and JavaScript array, providing at least one of XSL transformations and style sheets to render said data as an HTML document for presenting said information requests and said pre-defined response options to said information requests, providing at least one HTML form to collect information concerning said customer including selections of said pre-defined response options, providing JavaScript functions for assigning appropriate ones of said risk factors and said value factors to each one of said pre-selected supply chain services, associating selected ones of said pre-defined response options with said pre-selected supply chain services, calculating an overall indication of risk to said supplier associated with providing said pre-selected supply chain services and an overall indication of value to said customer associated with receiving said pre-selected supply chain services based on said risk and value factors assigned to each one of said pre-selected supply chain services, providing a VML program for rendering said overall indications of risk and value, and providing an HTML page for rendering appropriate ones of said supply chain services for possible implementation based on said overall risk and value.

59. The method according to claim 58, further comprising the step of populating said database with data representing non-qualifying services pre-selected as inappropriate for said pre-defined response options.

60. The method according to claim 58, wherein said information requests concern at least one of the identity of said customer, the size of said customer, said customer's market position, said customer's product complexity and mix, said customer's supply chain needs and requirements, said customer's infrastructure and practices, the supply chain related technologies employed by said customer, said customer's responsiveness and flexibility, and demand variability associated with said customer.

61. The method according to claim 58, wherein said pre-selected supply chain services include at least one of physical, informational, technical, and financial services provided by said supplier designed to confer value to said customer through increases in efficiencies in supply chain management and logistics.

62. The method according to claim 58, wherein said appropriate ones of said pre-selected supply chain services presented for possible implementation include those for which said supplier can recover the costs associated with providing said pre-selected supply chain services.

63. The method according to claim 58, wherein said risk factors are based on said supplier's historical risk experience regarding said associated pre-selected supply chain service relative to other supply chain services offered by said supplier.

64. The method according to claim 58, wherein said value factors are based on said supplier's historical customer value experience regarding said associated pre-selected supply chain service relative to other supply chain services offered by said supplier.

65. The method according to claim 58, further comprising the step of rendering in said HTML document said information concerning said customer, including said selected pre-defined response options, for verification by at least one of said supplier and customer prior to associating said selected pre-defined response options with said appropriate pre-selected supply chain services.

66. The method according to claim 58, wherein said risk and value factors are numeric values.

67. The method according to claim 66, wherein said step of calculating an overall indication of risk to said supplier associated with providing said pre-selected supply chain services includes computing the sum of said risk factors assigned to each one of said pre-selected supply chain services corresponding to said selected pre-defined response options to yield a risk factor sum and dividing said risk factor sum by the total number of said selected pre-defined response options.

68. The method according to claim 66, wherein said step of calculating an overall indication of value to said customer associated with receiving said pre-selected supply chain services includes computing the sum of said value factors assigned to each one of said pre-selected supply chain services corresponding to said selected pre-defined response options to yield a value factor sum and dividing said value factor sum by the total number of said selected pre-defined response options.

69. The method according to claim 58, wherein said step of rendering said overall indications of risk and value includes graphically displaying said overall indications of risk and value.

70. The method according to claim 69, wherein said overall indications of risk and value are represented as a point on a two-dimensional graph defined by x and y axes, said graph including a plurality of pre-defined regions, each of said regions being associated with a different pre-selected recommended course of action for said supplier regarding said customer, the location of said point on said graph with respect to said pre-defined regions indicating an appropriate one of said recommended courses of action.

71. The method according to claim 70, wherein said graph includes a first pre-defined region representing high overall value and low overall risk.

72. The method according to claim 71, wherein said pre-selected recommended course of action associated with said first pre-defined region is to proceed with framing said supply chain services for said customer.

73. The method according to claim 70, wherein said graph includes a second pre-defined region representing at least one combination of high overall value and high overall risk, moderate overall value and moderate risk, and low overall value and low overall risk.

74. The method according to claim 73, wherein said pre-selected recommended course of action associated with said second pre-defined region is to consult a supply chain solutions representative of said supplier for further guidance regarding said supply chain services for said customer.

75. The method according to claim 70, wherein said graph includes a third pre-defined region representing low overall value and high overall risk.

76. The method according to claim 75, wherein said pre-selected recommended course of action associated with said third pre-defined region is for said supplier to work with said customer to minimize the costs associated with providing said pre-selected supply chain services before proceeding with said supply chain services for said customer.

77. The method according to claim 69, wherein said overall indications of risk and value are represented as a bar graph including a first bar representing said overall risk and a second bar representing said overall value.

78. The method according to claim 58, further comprising the step of presenting in said HTML page directions for implementing said appropriate ones of said pre-selected supply chain services.

79. An Internet-based system for assessing supply chain services offered by a supplier of products to a customer of products, the system comprising a database populated with data representing information requests, pre-defined response options to said information requests, supply chain services pre-selected as appropriate for said pre-defined response options, risk factors representative of risk to said supplier associated with providing said pre-selected supply chain services, and value factors representative of value to said customer associated with receiving said pre-selected supply chain services, means for outputting said data into at least one of an XML data island and JavaScript array, at least one of XSL transformations and style sheets to render said data as an HTML document for presenting said information requests and said pre-defined response options to said information requests, at least one HTML form to collect information concerning said customer including selections of said pre-defined response options, JavaScript functions for assigning appropriate ones of said risk factors and said value factors to each one of said pre-selected supply chain services, associating selected ones of said pre-defined response options with said pre-selected supply chain services, calculating an overall indication of risk to said supplier associated with providing said pre-selected supply chain services and an overall indication of value to said customer associated with receiving said pre-selected supply chain services based on said risk and value factors assigned to each one of said pre-selected supply chain services, a VML program for rendering said overall indications of risk and value, and an HTML page for rendering appropriate ones of said supply chain services for possible implementation based on said overall risk and value.

80. The system according to claim 79, wherein said database further includes data representing non-qualifying services pre-selected as inappropriate for said pre-defined response options.

81. The system according to claim 79, wherein said information requests concern at least one of the identity of said customer, the size of said customer, said customer's market position, said customer's product complexity and mix, said customer's supply chain needs and requirements, said customer's infrastructure and practices, the supply chain related technologies employed by said customer, said customer's responsiveness and flexibility, and demand variability associated with said customer.

82. The system according to claim 79, wherein said pre-selected supply chain services include at least one of physical, informational, technical, and financial services provided by said supplier designed to confer value to said customer through increases in efficiencies in supply chain management and logistics.

83. The system according to claim 79, wherein said appropriate ones of said pre-selected supply chain services presented for possible implementation include those for which said supplier can recover the costs associated with providing said pre-selected supply chain services.

84. The system according to claim 79, wherein said risk factors are based on said supplier's historical risk experience regarding said associated pre-selected supply chain service relative to other supply chain services offered by said supplier.

85. The system according to claim 79, wherein said value factors are based on said supplier's historical customer value experience regarding said associated pre-selected supply chain service relative to other supply chain services offered by said supplier.

86. The system according to claim 79, wherein said information concerning said customer, including said selected pre-defined response options, is rendered in said HTML document for verification by at least one of said supplier and customer prior to the association of said selected pre-defined response options with said appropriate pre-selected supply chain services.

87. The system according to claim 79, wherein said risk and value factors are numeric values.

88. The system according to claim 87, wherein said risk factors assigned to each one of said pre-selected supply chain services corresponding to said selected pre-defined response options are summed to yield a risk factor sum and said risk factor sum is divided by the total number of said selected pre-defined response options.

89. The system according to claim 87, wherein said value factors assigned to each one of said pre-selected supply chain services corresponding to said selected pre-defined response options are summed to yield a value factor sum and said value factor sum is divided by the total number of said selected pre-defined response options.

90. The system according to claim 79, wherein said VML program is adapted to render said overall indications of risk and value graphically.

91. The system according to claim 90, wherein said overall indications of risk and value are represented as a point on a two-dimensional graph defined by x and y axes, said graph including a plurality of pre-defined regions, each of said regions being associated with a different pre-selected recommended course of action for said supplier regarding said customer, the location of said point on said graph with respect to said pre-defined regions indicating an appropriate one of said recommended courses of action.

92. The system according to claim 91, wherein said graph includes a first pre-defined region representing high overall value and low overall risk.

93. The system according to claim 92, wherein said pre-selected recommended course of action associated with said first pre-defined region is to proceed with framing said supply chain services for said customer.

94. The system according to claim 91, wherein said graph includes a second pre-defined region representing at least one combination of high overall value and high overall risk, moderate overall value and moderate risk, and low overall value and low overall risk.

95. The system according to claim 94, wherein said pre-selected recommended course of action associated with said second pre-defined region is to consult a supply chain representative of said supplier for further guidance regarding said supply chain services for said customer.

96. The system according to claim 91, wherein said graph includes a third pre-defined region representing low overall value and high overall risk.

97. The system according to claim 96, wherein said pre-selected recommended course of action associated with said third pre-defined region is for said supplier to work with said customer to minimize the costs associated with providing said pre-selected supply chain services before proceeding with said supply chain services for said customer.

98. The system according to claim 90, wherein said overall indications of risk and value are represented as a bar graph including a first bar representing said overall risk and a second bar representing said overall value.

99. The system according to claim 79, wherein said HTML page includes directions for implementing said appropriate ones of said pre-selected supply chain services.

100. A method for assessing supply chain services for presentation by a supplier of products to a customer of said products, the method comprising the steps of obtaining information concerning said customer, including by presenting information requests having associated pre-defined response options and obtaining selections of said pre-defined response options, associating said selected pre-defined response options with supply chain services pre-selected as appropriate for said pre-defined response options, further associating said selected pre-defined options with non-qualifying services pre-selected as inappropriate for said pre-defined response options, each one of said pre-selected supply chain services having a risk weight and a value weight, said risk weight being representative of relative risk to said supplier associated with providing said pre-selected supply chain service, and said value weight being representative of relative value to said customer associated with receiving said pre-selected supply chain service, based on said risk and value weights assigned to each one of said pre-selected supply chain services corresponding to said selected response options, simultaneously calculating an overall indication of risk to said supplier associated with providing said pre-selected supply chain services and an overall indication of value to said customer associated with receiving said pre-selected supply chain services, correlating said overall indications of risk and value, and based on said correlation of overall risk and value, presenting appropriate ones of said pre-selected supply chain services for possible implementation.
